(19) United States
(12) Patent Application Publication
(10) Pub. No.: US 2008/0047386 A1
(43) Pub. Date: Feb. 28, 2008

(54) Automotive foot pedal assembly

(76) Inventors: Jason R. Ridgway, Bay City, MI (US); Sam L. Scrivener, Durand, MI (US)

Correspondence Address: MICHAEL D. SMITH;DELPHI TECHNOLOGIES, INC., P.O. BOX 5052, MAIL CODE: 480-410-202, TROY, MI, 48007-5052, US

(21) Appl. No.: 11/500,223

(22) Filed: Aug. 7, 2006

(51) Int. Cl. G05G 1/14

(52) U.S. Cl. 74/512

(57) ABSTRACT

An automotive foot pedal assembly including a first member with a foot pedal pivotally supported on an automotive structure, a second member operably coupled to the brake system and a frictional coupling. During normal operation, a force applied to the foot pedal pivotally moves the first member and the frictional coupling transmits this force to the second member to thereby controllably operate the brake system. Upon the application of a force exceeding a threshold value, the frictional coupling permits relative movement between the first and second members and at least partially dissipates the force. Upon diminution of the force below a second value, the frictional coupling operably re-couples the first and second members in a post-event configuration which allows the foot pedal assembly to control the operation of the brake system. The operational range of the first member is smaller in the post-event configuration than in the original configuration.

### BACKGROUND OF THE INVENTION

1. Field of the Invention

The present invention relates to automotive foot pedal assemblies, and, more specifically, to foot pedal assemblies that can reduce the risk of injury to the operator of the automotive vehicle in a collision or other similar event.

2. Description of the Related Art

Most automotive vehicles have brake systems with a foot pedal wherein depression of the foot pedal.by the driver of the vehicle activates the brake system. Generally, the brake system exerts a force on the foot pedal that urges the foot pedal towards the driver.

In a frontal collision that results in the deformation of the vehicle, the foot pedal for operating the brake system can be displaced toward the driver. In such a collision, it is quite common for the driver to be applying pressure to the brake pedal with a foot. As a result, the rearward displacement of the brake pedal during the collision can result in leg injuries to the driver. Furthermore, the hydraulic pressure in the brake system may reach elevated levels during the collision whereby the biasing force exerted on the brake pedal urging the pedal against the foot of the driver is also increased.

Various foot pedal assemblies have been developed to reduce the risk of leg injuries to the driver in the event of a collision. In some designs, the linkage between the brake system and the brake pedal is severed or otherwise broken during a collision so that the brake pedal is no longer biased toward the driver by the brake system. This allows the brake pedal to fall away from the foot of the driver under no, or very limited pressure. In some circumstances, however, it may be desirable for the driver to have the ability to apply a braking force immediately following an initial collision. By completely severing the link between the brake pedal and the brake system, the brake pedal can no longer be used to operate the brake system after the initial collision.

Other designs allow the brake pedal to “collapse” during a collision and then apply a biasing force to return the brake pedal to its original position following the collision. Such designs provide a brake pedal that allows the brake system to be activated following the collision. The biasing of the brake pedal to its original position following the collision, however, can be considered undesirable because of its potential to cause the brake pedal to impinge upon the leg of the driver.

Although the known foot pedal assemblies provide benefits in a collision, further improvements are desirable.

### SUMMARY OF THE INVENTION

The present invention provides an automotive foot pedal assembly that dissipates some of the force applied to the foot pedal during an event such as collision when the applied force exceeds a threshold value. The foot pedal assembly does not force the foot pedal assembly into its original configuration, yet still permits the foot pedal assembly to provide at least partial functionality in its post-event configuration.

The invention comprises, in one form thereof, an automotive foot pedal assembly adapted for use in an automotive structure having a brake system. The foot pedal assembly includes a first member pivotally supported on the automotive structure, a foot pedal disposed on the first member, a second member operably coupled to the brake system and a frictional coupling operably coupling the first and second members. During normal operation, the first member defines a first pivotal range of operation wherein a force applied to the foot pedal causes pivotal movement of the first member, the frictional coupling transmitting at least a portion of the applied force from the pivoting first member to the second member, the second member thereby controllably operating the brake system. Upon the application of a force to the foot pedal exceeding a threshold value, the frictional coupling permits relative movement between the first and second members and at least partially dissipates the threshold value exceeding force. Upon diminution of the force below a second value, the frictional coupling operably re-couples the first and second members in a post-event configuration. In the post-event configuration, the first member defines a second pivotal range of operation wherein a force applied to the foot pedal causes pivotal movement of the first member, the frictional coupling transmitting at least a portion of the applied force from the pivoting first member to the second member, the second member thereby controllably operating the brake system. The second pivotal range of operation is smaller than the first pivotal range of operation.

The invention comprises, in another form thereof, an automotive foot pedal assembly adapted for use with an automotive structure having a brake system. The foot pedal assembly includes a pivot stud supported on the automotive structure, a first member pivotally mounted on the pivot stud, a foot pedal disposed on the first member, a second member pivotally mounted on the pivot stud and operably coupled to the brake system, and a frictional coupling operably coupling said first and second members. The first and second members are each pivotal about a common axis defined by the pivot stud. During normal operation, the first member defines a first pivotal range of operation wherein a force applied to the foot pedal causes pivotal movement of the first member, the pivotal movement of the first member being transmitted to the second member by the frictional coupling without relative movement between the first and second members and wherein the second member thereby controllably operates the brake system. Upon the application of a force to the foot pedal exceeding a threshold value, the frictional coupling permits relative movement between the first and second members and at least partially dissipates the threshold value exceeding force. Upon diminution of the force below a second value, the frictional coupling operably re-couples the first and second members in a post-event configuration. In the post-event configuration, the first member defines a second pivotal range of operation wherein a force applied to the foot pedal causes pivotal movement of the first member, the pivotal movement of the first member being transmitted to the second member by the frictional coupling without relative movement between the first and second members and wherein the second member thereby controllably operates the brake system. The second pivotal range of operation is smaller than the first pivotal range of operation and the operation of the frictional coupling is independent of relative movement between the frictional coupling the automotive structure.

In some embodiments of the invention, the frictional coupling includes a tolerance ring that operably couples the first and second members.

In other embodiments of the invention, the first member includes a first frictional engagement surface and the second member includes a second frictional engagement member and the frictional coupling includes a biasing member that biases the first and second frictional engagement members into frictional engagement. A shear pin may optionally be employed to increase the magnitude of the threshold value of the frictional coupling that must be exceeded to permit the relative movement of the first and second members.

An advantage of the present invention is that it dissipates some of the force applied to the foot pedal when the applied force exceeds a threshold value.

Another advantage is that, without biasing the foot pedal assembly into its original configuration which might exert an undesirable force on the leg of the vehicle operator, the foot pedal assembly remains at least partially functional in its post-event configuration.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a first embodiment of the invention.

FIG. 2 is a cross sectional view taken along line 2-2 of FIG. 1.

FIG. 3 is a side view of the first embodiment.

FIG. 4 is a perspective view of a second.embodiment of the invention.

FIG. 5 is a partial front view of the second embodiment.

FIG. 6 is a partial perspective view of an embodiment with a shear pin.

FIG. 7 is a cross sectional view taken along line 7-7 of FIG. 6.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

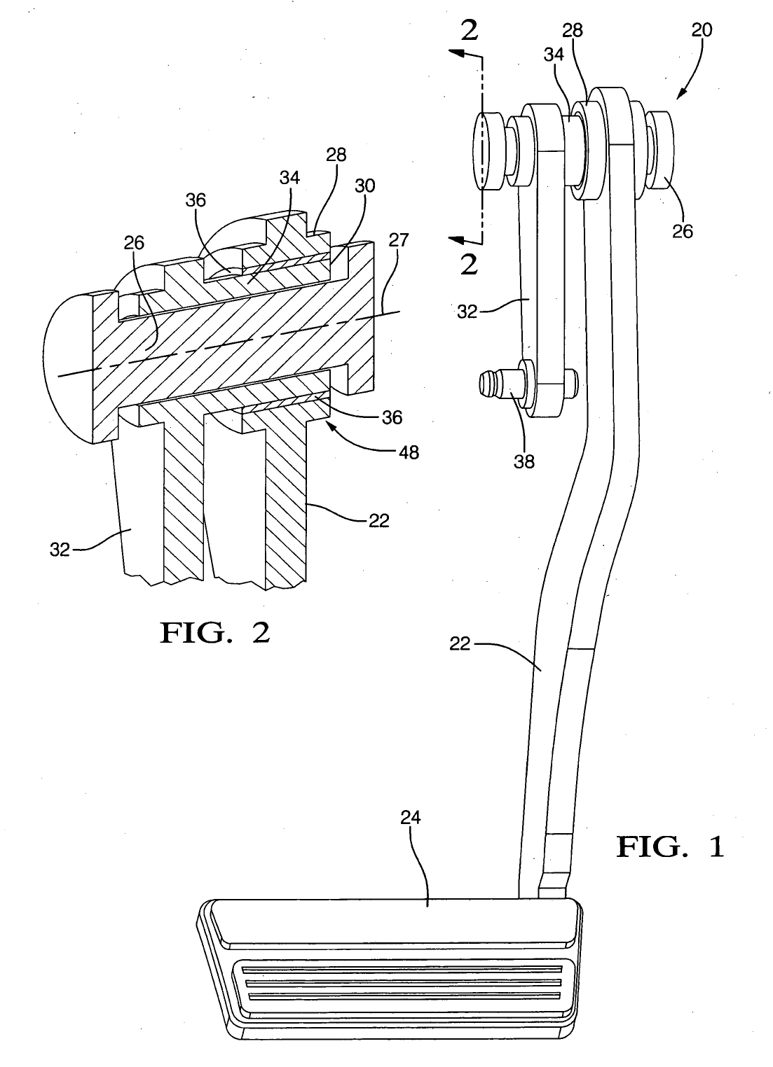

An automotive foot pedal assembly 20 in accordance with the present invention is illustrated in FIG. 1. Assembly 20 includes a first member 22 having a foot pedal 24 mounted thereon. First member 22 is pivotally mounted on pivot stud 26. As discussed in greater detail below, when the operator of the vehicle in which assembly 20 is installed applies a force to foot pedal 24, first member 22 rotates about pivot stud 26 to thereby activate brake system 44.

As best seen in FIG. 2, first member 22 includes a hub 28 that encircles pivot stud 26 and defines an annular space 30 between hub 28 and pivot stud 26. A second member 32 is also pivotally mounted on pivot stud 26 and includes a sleeve 34 that projects into annular space 30. In the illustrated embodiment both first and second members 22, 32 are pivotal about common axis 27 defined by pivot stud 26. A tolerance ring 36, schematically depicted in FIG. 2, is located in annular space 30 and is positioned radially between and engages sleeve 34 and hub 28 to thereby operably couple first and second members 22, 32.

Although the illustrated embodiment shows hub 28 on first member 22 and sleeve 34 on second member 32, other configurations are also possible. For example, hub 28 could be on second member 32 and sleeve 34 could be located on first member 22. Alternatively, a separate sleeve rotatable on pivot stud 26 could extend through hubs on each of first and second members 22, 32 and two separate tolerance rings could be used to connect the separate sleeve to each of first and second members 22, 32.

Tolerance rings generally take the form of a linear corrugated metal strip that has been bent into a substantially circular ring-shape and is fitted between two mechanical parts in an interference fit to thereby secure the two parts together. Tolerance rings transfer torques between the two parts being secured by frictional engagement unless the torque exceeds a threshold value dependent upon the design of the parts and the tolerance ring at which point one of the parts will slip relative to the ring and whereby the two parts will slip relative to each other. Tolerance rings are well known to those having ordinary skill in the art and are often used to hold a bearing on a shaft or secure a bearing in a housing.

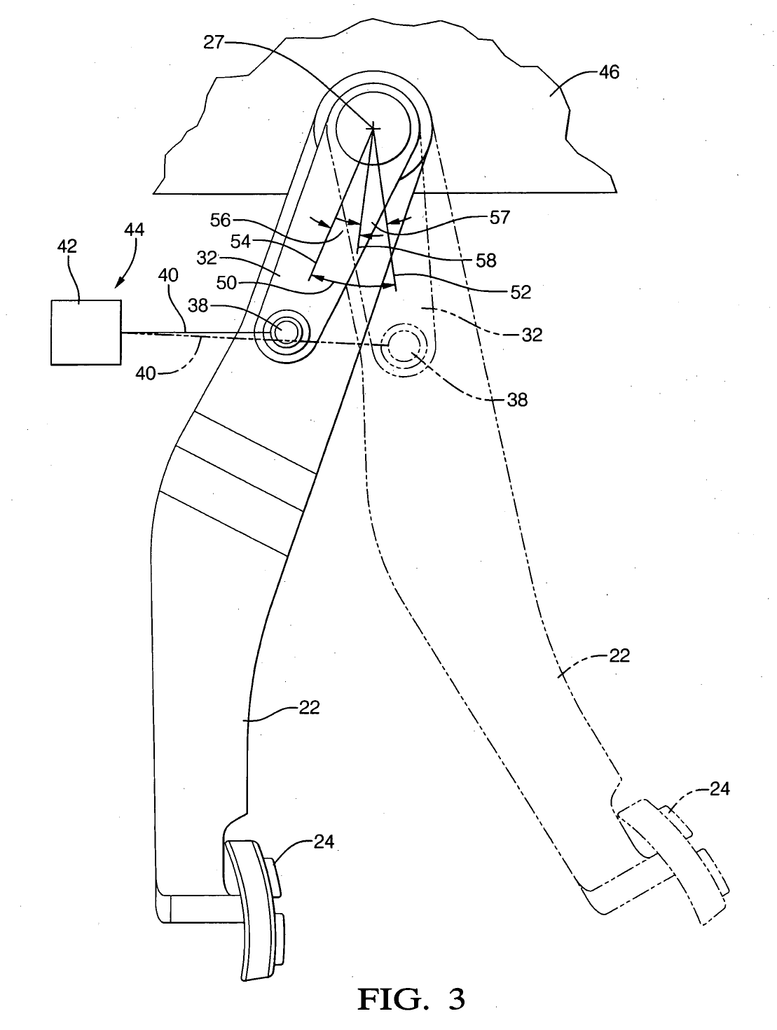

Turning to FIG. 3, second member 32 includes a brake booster pivot stud 38. A brake booster rod 40 (shown schematically) is mounted to stud 38 and operates vacuum brake booster 42 to thereby operably couple second member 32 to the brake system 44 of the vehicle. Booster rod 40, vacuum brake booster 42 and brake system 44 have a conventional design and operate in a manner well known in the art. As second member 32 is pivoted about pivot stud 26 by the depression and release of foot pedal 24, second member 32 moves booster rod 40 to thereby controllably operate the brake system 44. Although a brake system 44 with a vacuum brake booster 42 is shown in the illustrated embodiment, the present invention may also be used with other types of brake systems.

As can also be seen in FIG. 3, pivot stud 26 is mounted on automotive structure 46 to thereby pivotally support first and second members 22, 32 on automotive structure 46. Automotive. structure 46 may be any suitable portion of the structure of the vehicle in which assembly 20 is installed. Typically, assembly 20 will be mounted to an automotive structure 46 that is not readily deformed during a collision.

During normal operation of the vehicle, the operator applies a force to foot pedal 24 to activate the brakes. As this force is applied to foot pedal 24, first member 22 is rotated about pivot stud 26. Frictional coupling 48, which is formed by tolerance ring 36 and its interface with first and second members 22, 32 in the embodiment illustrated in FIGS. 1-3, operably couples first and second members 22, 32 such that second member 32 is rotated together with first member 22 without any relative movement between first and second members 22, 32. The force applied to foot pedal 24 is thereby transmitted from first member 22 by frictional coupling 48 to second member 32. As second member 32 is pivoted, it moves brake booster rod 40 connected to stud 38 to operate the brake system 44 in a manner well known in the art.

The first member defines a first pivotal range of operation during normal operation as schematically depicted by range 50 in FIG. 3. As first member 22 moves through this range of operation, frictional coupling 48 moves second member 32 through a similar range of operation and, consequently, moves brake booster rod to controllably operate brake system 44. Normal range of operation 50 represents the pivotal movement of first member 22 between a first position 52 where the operator is not applying a force to foot pedal 24, the brake system is not actuated, and brake booster rod 40 biases pedal 24 towards the operator, and a second position 54 where the operator has depressed foot pedal 24 as far as possible towards the floor pan of the vehicle and the brake system has been maximally actuated.

When a force exceeding a threshold value of frictional coupling 48 is applied to foot pedal 24, frictional coupling 48 permits slipping, i.e., relative rotational movement between first and second members 22, 32. In a collision where a forward traveling vehicle is brought to a sudden stop while the operator is applying the brakes, a large force exceeding the threshold value of frictional coupling 48 may be applied to foot pedal 24. In such an event, the slippage at frictional coupling 48 will result in first member 22 rotating towards position 54 while second member 32 remains stationary. The frictional resistance of coupling 48 to this relative movement partially dissipates the force that is being applied to foot pedal 24. This dissipation of force enhances the safety of the operator of the vehicle because some of the dissipated force will have been the result of the forward momentum of the operator of the vehicle. Frictional coupling 48 also enhances the safety of the operator because, prior to first member 22 bearing against a structural feature of the vehicle, the maximum force that foot pedal 24 can apply to resist the forward motion of the operator is determined by the threshold value at which frictional coupling 48 begins to slip.

After the force being applied to foot pedal 24 is diminished below a second value, frictional coupling 48 will re-couple first and second members 22, 32 together. Generally, the second force value at which this re-coupling takes place will be less than the value of the threshold value at which relative movement between first and second members 22, 32 is initiated. Because some relative movement of first and second members 22, 32 has taken place, when frictional coupling 48 re-couples the first and second members 22, 32, members 22, 32 will be in a post-event configuration that differs from the original configuration of members 22, 32.

In this post-event configuration, first member 22 will not be biased forward to position 52, instead first member will only be biased forward to an intermediate position 58 which is dependent upon the amount of slippage that occurred prior to the re-coupling of first and second members 22, 32. In FIG. 3, angular range 57 corresponds to the amount slippage that has occurred between members 22, 32. In this post-event configuration, first member 22 can be depressed from intermediate position 58 to position 54 to at least partially activate brake system 44. Thus, in the post-event configuration, first member 22 defines a second pivotal range of operation 56 wherein a force applied to foot pedal 24 causes pivotal movement of the first member which is transmitted to the second member 32 to thereby controllably operate the brake system. As can be seen in FIG. 3, this second range of operation 56 is less than the first range of operation 50.

It is noted that, in the post-event configuration, when first member 22 returns to intermediate position 58, second member 32 will be in the position in which second member 32 is shown in dashed lines in FIG. 3 (i.e., the position at which brake system 44 is inactivated). When first member 22 is fully depressed to position 54, second member 32 will have traveled through an arc corresponding to angular range of motion 56 but will not-be in the position second member 32 is shown in solid lines in FIG. 3 which would require second member 32 to travel through the greater range of motion 50. Thus, in the post-event configuration, when foot pedal 24 and first member 22 are fully depressed, second member 32 will activate brake system 44 but not to the same extent as when first member 22 was fully depressed in the original configuration. (If position 58 was at the halfway point between positions 52 and 54, then first member 22 would start at position 58 and end at position 54 and second member 32 would start at position 52 and end at position 58 when the operator of the vehicle fully depressed pedal 24 in its post-event configuration.)

As will be understood from the description set forth above, the operation of the frictional coupling 48 is independent of relative movement between frictional coupling 48 and automotive structure 46. In other words, frictional coupling 46 does not require the deformation of automotive structure 46 in a collision to bring frictional coupling 48 into contact, or out of engagement, with the surrounding automotive structure 46 to permit the relative movement of first and second members 22, 32. Instead, it is the magnitude of the force being applied to the frictional coupling 48 via pedal 24 that determines whether or not such relative movement will take place.

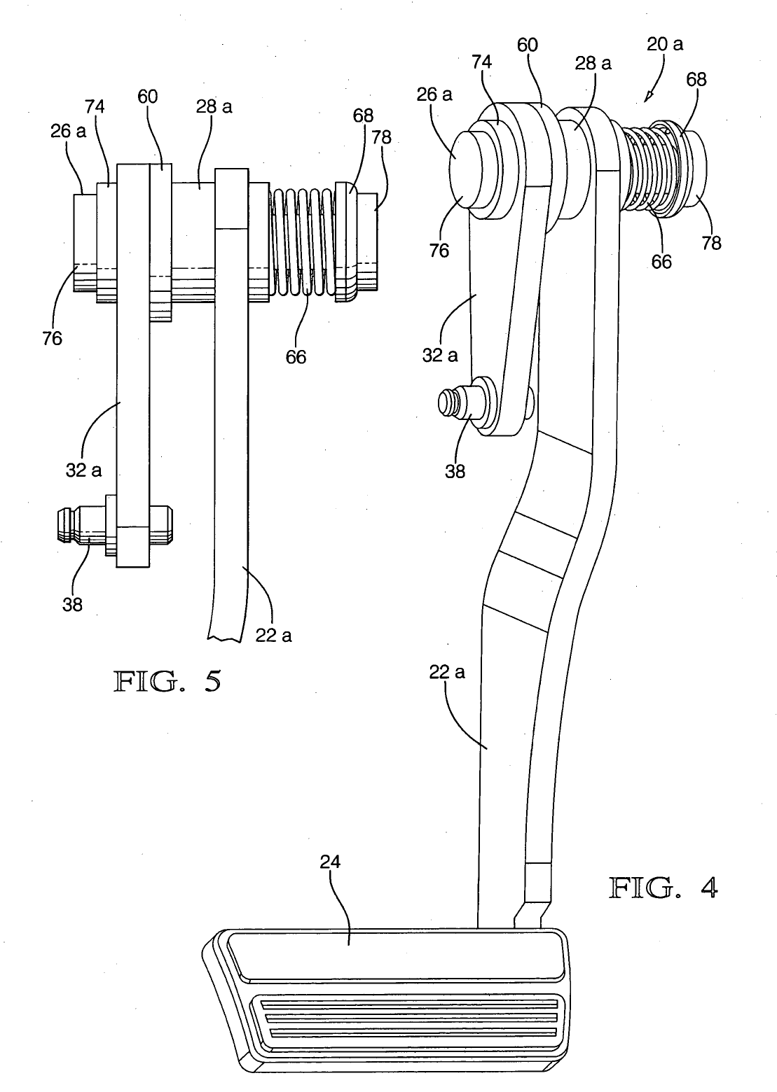

Another embodiment of a foot pedal assembly is shown in FIGS. 4-7. Foot, pedal assembly 20a is generally similar to assembly 20 but includes an alternative frictional coupling 48a. In assembly 20a, first and second members 22a, 32a are pivotally mounted on pivot stud 26a and pivot about a common axis 27a defined by pivot stud 26a. Frictional coupling 48a is formed by biasing members 22a, 32a into direct frictional engagement.

First member 22a defines a first frictional engagement surface 62 while second member 32a defines a second frictional engagement surface 64. Biasing member 66, which takes the form of a helical compression spring in the illustrated embodiment, biases surfaces 62, 64 into engagement. The major portions of first and second frictional engagement surfaces 62, 64 are disposed substantially perpendicular to common axis 27a and biasing member 66 disposed on pivot stud 26a exerts a force parallel to common axis 27a to forcibly engage surfaces 62, 64.

Various alternative designs of frictional engagement surfaces 62, 64 may also be employed with the present invention. Additionally, an intermediate separate part positioned between surfaces 62, 64 could be used to engage surfaces 62, 64 in the operable coupling of first and second members 22a, 32a whereby surfaces 62, 64 would be indirectly engaged through such an intermediate separate part.

In the illustrated embodiment, one end of spring 66 bears against an end cap 68 with a retaining lip 69 along its outer perimeter. End cap 68 thereby retains spring 66 on pivot stud 26a and bears against pivot head 78. The end of spring 66 opposite end cap 68 is seated in circular recess 67 located on an end wall 72 on first member 22a. End wall 72 extends radially inwardly and helps to retain first member 22a in a centered position as it rotates about common axis 27a.

The action of spring 66 biases first engagement surface 62 located on a radial flange 60 on first member 22a into engagement with second frictional engagement surface 64 second member 32a. Second member 32a has a circular flange 74 opposite surface 64 that bears against pivot head 76 on pivot stud 26a.

As best seen in FIG. 7 (which illustrates the use of an optional shear pin 70), first member 22a includes a hub 28a which defines an annular space 30a between hub 28a and pivot stud 26a and second member 32a includes a sleeve 34a disposed within annular space 30a. Radially inward facing surface 29 of hub 28a and radially outward facing surface 35 of sleeve 34a are also frictionally engaged and contribute to the frictional resistance of coupling 48a.

Similar to assembly 20, assembly 20a illustrated in FIGS. 4 and 5, has a first member 22a that defines a first range of operation 50 in its original configuration that is larger than its range of operation 56 in a post-event configuration after the threshold value of frictional coupling 48a has been exceeded, slippage between members 22a and 32a has occurred, and the force applied to pedal 24 has decreased below a second value at which frictional coupling 48a has re-coupled first and second members 22a, 32a.

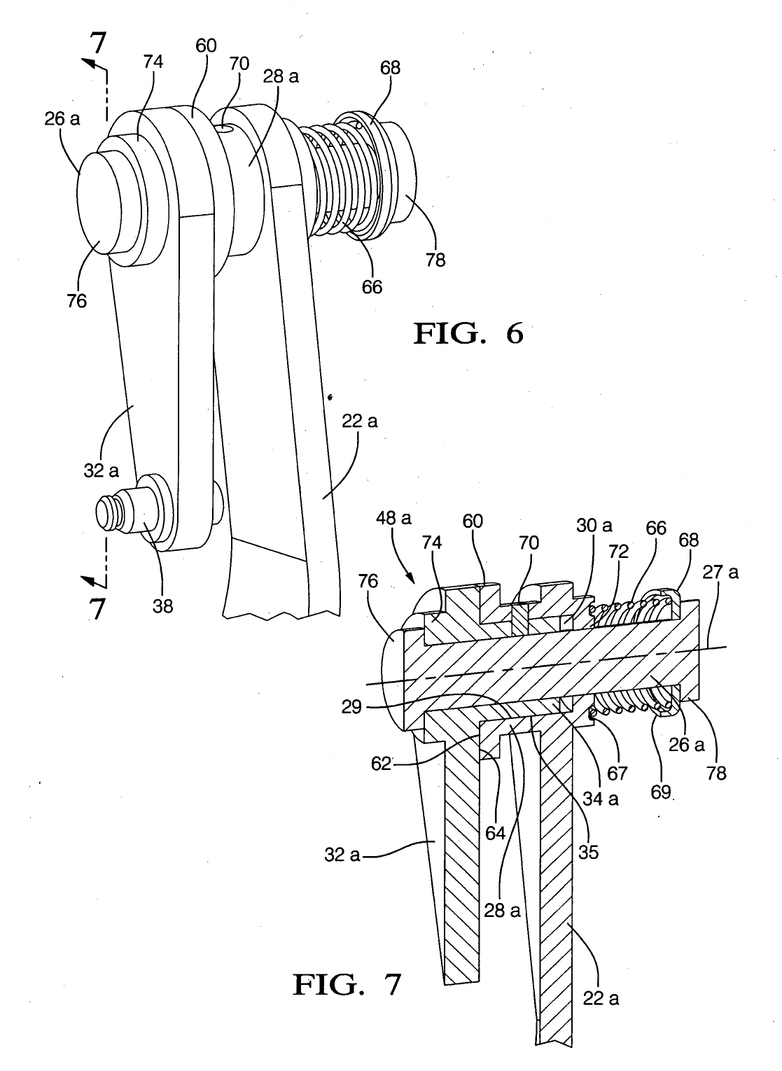

As illustrated in FIGS. 6 and 7, assembly 20a may optionally include a shear pin 70. In the embodiment illustrated in FIGS. 6 and 7, shear pin 70 extends through aligned radially extending openings in hub 28a and sleeve 34a. Shear pin 70 rotationally couples first and second members 22a, 32a and the resistance of shear pin 70 to relative movement between first and second members 22a, 32a contributes to the magnitude of the threshold value of the force which must be applied to foot pedal 24 to initiate the relative movement of first and second members 22a, 32a.

When the threshold force value is exceeded, shear pin 70 is severed at the interface between hub 28a and sleeve 34a resulting in the relative motion of first and second members 22a and 32a. After shear pin 70 has been severed, frictional coupling 48a depends upon the frictional engagement of surfaces 62, 64 to re-couple first and second members 22a, 32a together. Thus, by including a shear pin 70 in assembly 20a, the magnitude of the threshold value of the force applied to foot pedal 24 required to first initiate relative movement between first and second members 22a, 32a is increased but the operation of assembly 20a is otherwise unaffected.

While this invention has been described as having an exemplary design, the present invention may be further modified within the spirit and scope of this disclosure. This application is therefore intended to cover any variations, uses, or adaptations of the invention using its general principles.

What is claimed is:

1. An automotive foot pedal assembly adapted for use in an automotive structure having a brake system, said foot pedal assembly comprising:
a first member. pivotally supported on the automotive structure;
a foot pedal disposed on said first member;
a second member operably coupled to the brake system;
a frictional coupling operably coupling said first and second members;
wherein, during normal operation, said first member defines a first pivotal range of operation wherein a force applied to said foot pedal causes pivotal movement of said first member, said frictional coupling transmitting at least a portion of the applied force from said pivoting first member to said second member, said second member thereby controllably operating the brake system; and
wherein, upon the application of a force to said foot pedal exceeding a threshold value, said frictional coupling permitting relative movement between said first and second members and at least partially dissipating said threshold value exceeding force, and wherein, upon diminution of said force.below a second value, said frictional coupling operably re-couples said first and second members in a post-event configuration; in said post-event configuration, said first member defines a second pivotal range of operation wherein a force applied to said foot pedal causes pivotal movement of said first member, said frictional coupling transmitting at least a portion of the applied force from said pivoting first member to said second member, said second member thereby controllably operating the brake system, said second pivotal range of operation being smaller than said first pivotal range of operation.

2. The automotive foot pedal assembly of claim 1 wherein said second member is pivotally supported on the automotive structure and wherein each of said first and second members pivot about a common axis and said frictional coupling rotatably couples said first and second members together.

3. The automotive foot pedal assembly of claim 2 wherein said frictional coupling comprises a tolerance ring.

4. The automotive foot pedal assembly of claim 3 further comprising a pivot stud supported on the automotive structure and defining said common axis, each of said first and second members being pivotally mounted on said pivot stud; and wherein one of said first and second members includes a hub defining an annular space between said hub and said pivot stud and the other of said first and second members defines a sleeve disposed within said annular space, said tolerance ring being disposed within said annular space and coupling said sleeve with said hub.

5. The automotive foot pedal assembly of claim 2 further comprising a pivot stud defining said common axis, said first and second members each being pivotally mounted on said pivot stud, said first member defining a first frictional engagement surface, said second member defining a second frictional engagement surface, said frictional coupling comprising a frictional engagement of said first and second frictional engagement surfaces and a biasing member biasing said first and second frictional engagement surfaces into frictional engagement.

6. The automotive f6ot pedal assembly of claim 5 further comprising a shear pin rotationally coupling said first and second members, resistance of said shear pin to relative movement between said first and second members contributing to the magnitude of said threshold value.

7. The automotive foot pedal assembly of claim 5 wherein said first and second frictional engagement surfaces are at least partially disposed substantially perpendicular to said common axis and said biasing member comprises a spring disposed on said pivot stud and exerting a biasing force parallel to said common axis.

8. The automotive foot pedal assembly of claim 7 wherein one of said first and second members includes-a hub defining an annular space between said hub and said pivot stud and the other of said first and second members defines a sleeve disposed within said annular space.

9. The automotive foot pedal assembly of claim 8 further comprising a shear pin rotationally coupling said sleeve with said hub, resistance of said shear pin to relative movement between said first and second members contributing to the magnitude of said threshold value.

10. The automotive foot pedal assembly of claim 1 wherein the operation of said frictional coupling is independent of relative movement between said frictional coupling and the automotive structure.

11. An automotive foot pedal assembly adapted for use with an automotive structure having a brake system, said foot pedal assembly comprising:
a pivot stud supported on the automotive structure;
a first member pivotally mounted on said pivot stud;
a foot pedal disposed on said first member;
a second member pivotally mounted on said pivot stud and operably coupled to the brake system, said first and second members each being pivotal about a common axis defined by said pivot stud;
a frictional coupling operably coupling said first and second members;
wherein, during normal operation, said first member defines a first pivotal range of operation wherein a force applied to said foot pedal causes pivotal movement of said first member, said pivotal movement of said first-member being transmitted to said second member by said frictional coupling without relative movement between said first and second members and wherein said second member thereby controllably operates the brake system; and
wherein, upon the application of a force to said foot pedal exceeding a threshold value, said frictional coupling permits relative movement between said first and second members and at least partially dissipates said threshold value exceeding force, and wherein, upon diminution of said force below a second value, said frictional coupling operably re-couples said first and second members in a post-event configuration, in said post-event configuration, said first member defines a second pivotal range of operation wherein a force applied to said foot pedal causes pivotal movement of said first member, said pivotal movement of said first member being transmitted to said second member by said frictional coupling without relative movement between said first and second members and wherein said second member thereby controllably operates the brake system, said second pivotal range of operation being smaller than said first pivotal range of operation and wherein the operation of said frictional coupling is independent of relative movement between said frictional coupling the automotive structure.

12. The automotive foot pedal assembly of claim 11 wherein said frictional coupling comprises a tolerance ring.

13. The automotive foot pedal assembly of claim 12 wherein one of said first and second members includes a hub defining an annular space between said hub and said pivot stud and the other of said first and second members defines a sleeve disposed within said annular space, said tolerance ring being disposed within said annular space and coupling said sleeve with said hub.

14. The automotive foot pedal assembly of claim 11 wherein said first member defines a first frictional engagement surface disposed substantially perpendicular to said common axis, said second member defines a second frictional engagement surface disposed substantially perpendicular to said common axis, said frictional coupling comprising a frictional engagement of said first and second frictional engagement surfaces and a biasing member biasing said first and second frictional engagement surfaces into frictional engagement.

15. The automotive foot pedal assembly of claim 14 further comprising a shear pin rotationally coupling said first and second members, resistance of said shear pin to relative movement between said first and second members contributing to the magnitude of said threshold value.

16. The automotive foot pedal assembly of claim 14 wherein said biasing member is a spring disposed on said pivot stud.

17. The automotive foot pedal assembly of claim 16 wherein one of said first and second members includes a hub defining an annular space between said hub and said pivot stud and the other of said first and second members defines a sleeve disposed within said annular space.

18. The automotive foot pedal assembly of claim 17 further comprising a shear pin rotationally coupling said sleeve with said hub, resistance of said shear pin to relative movement between said first and second members contributing to the magnitude of said threshold value.
